(19) United States
(12) Patent Application Publication
(10) Pub. No.: US 2007/0063135 A1
(43) Pub. Date: Mar. 22, 2007

(54) Image sensing device package structure

(76) Inventor: Po-Hung Chen, Shin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/230,731

(22) Filed: Sep. 21, 2005

(51) Int. Cl. H01J 40/14

(52) U.S. Cl. 250/239

(57) ABSTRACT

An image sensing device package structure is formed by using a base and a light transparent layer to package an image sensing device. The image sensing device is electrically connected to metallization traces on the base by means of wire bonding. Through change of the positions of the metallization traces, contacts between bonding wires and the metallization traces are made slightly higher than the top of the image sensing device, thereby shortening the wire bonding pitch of the bonding wires and thus reducing the package area.

### BACKGROUND OF THE INVENTION

1. Field of the Invention

The present invention relates to an image sensing device package structure and, more particularly, to an image sensing device package structure capable of reducing the package area.

2. Description of Related Art

As shown in FIG. 1, a conventional CMOS image sensing device package structure comprises a substrate 10, a frame 20, an image sensing device 30, and a light transparent glass 40. Several metallization traces 11 are provided on the surface of the substrate 10. The frame 20 is adhered to the substrate 10 using a first glue layer 12. The image sensing device 30 adheres to the substrate 10. The image sensing device 30 has an image sensing area 31. The image sensing device 30 is connected to the metallization traces 11 on the surface of the substrate 10 via bonding wires 32 by means of wire bonding to achieve electric connection between the image sensing device 30 and the substrate 10. The light transparent glass 40 seals the substrate 10 using a second glue layer 13. This package structure can be isolated from outside contaminants so that the CMOS image sensing device can truly sense the exterior environment.

The above conventional package structure, however, has a primary drawback, Because the image sensing device 30 has a height different with respect to the substrate 10 during wire bonding, a corresponding wire bonding pitch S1 is required. Moreover, when wire bonding is performed between the image sensing device 30 and the substrate 10, a distance S2 is kept between the frame 20 and the metallization traces 11 on the substrate 10 to prevent the capillary tip from touching the frame 20. Therefore, there is much limit in the package area and volume of this package structure, hence being adverse to applications in portable products.

### SUMMARY OF THE INVENTION

An object of the present invention is to provide an image sensing device package structure, in which wire bonding positions of an image sensing device are changed to shorten the wire bonding pitch for reducing the package area, thereby accomplishing a miniaturized package of the image sensing device.

To achieve the above object, an image sensing device package structure of the present invention comprises an image sensing device, a base, and a light transparent layer. The base has an upper surface and a lower surface. Several metallization traces are provided on the upper and lower surfaces. More than one bonding wire is used to connect the metallization traces on the upper surface with the image sensing device. The horizontal height of the top of the metallization traces on the upper surface is slightly larger than that of the top of the image sensing device to reduce the wire bonding pitch of bonding wire. The light transparent layer covers on the upper surface of the base.

More specifically speaking, the difference between the horizontal heights of the top of the metallization traces on the upper surface of the base and the top of the image sensing device can be larger than 0.1 mm, and is preferred to be larger than 0.2 mm. The difference between the horizontal heights of the bottom of the light transparent layer and the top of the image sensing device can be smaller than 0.6 mm, and is preferred to be smaller than 0.4 mm. The difference between the horizontal heights of the light transparent layer and the top of the metallization traces on the upper surface of the base can be smaller than 0.5 mm or 0.3 mm, and is preferred to be smaller than 0.2 mm.

In the embodiment of the present invention, in order to change positions of the metallization traces, a groove is formed on the upper surface of the base. A first upper surface is formed at the bottom of the groove. The image sensing device is installed on the first upper surface. The edge of the groove has a difference in height to form a second upper surface and a third upper surface. The horizontal height of the second upper surface is larger than that of the first upper surface. The horizontal height of the third upper surface is larger than that of the second upper surface. Several metallization traces are disposed on the second upper surface and the lower surface of the base. The image sensing device is connected to the metallization traces on the second upper surface via more than one bonding wire to achieve electric connection with the base. The light transparent layer covers on the third upper surface of the base so that the image sensing device can be covered in the light transparent layer and the base. In order to reduce the wire bonding pitch of bonding wire and also meet the requirement for the wire bonding height of bonding wire, the horizontal height of the second upper surface of the base is designed to be larger than that of the upper surface of the image sensing device so as to accomplish miniaturized package.

Furthermore, in the above embodiment, the difference between the horizontal heights of the third upper surface and the second upper surface of the base can decrease to prevent the capillary tip from touching the edge of the base when performing bonding wire ball bonding. The required length of the second upper surface of the base can thus be reduced to shrink the area and volume of the package structure.

### BRIEF DESCRIPTION OF THE DRAWINGS

The various objects and advantages of the present invention will be more readily understood from the following detailed description when read in conjunction with the appended drawing, in which:

FIG. 1 is a diagram of a conventional CMOS image sensing device package structure;

FIG. 2 is a diagram of an image sensing device package structure according to an embodiment of the present invention;

FIG. 3 is a diagram of an image sensing device package structure having a fastening portion according to another embodiment of the present invention;

FIG. 4 is a diagram of an image sensing device package structure with a shaped metallization trace disposed at the inside and the outside of the base according to another embodiment of the present invention; and

FIG. 5 is a diagram of an image sensing device package structure with a shaped metallization trace disposed at the inside of the base according to another embodiment of the present invention.

### DETAILED DESCRIPTION OF THE PREFERRED EMBODIMENTS

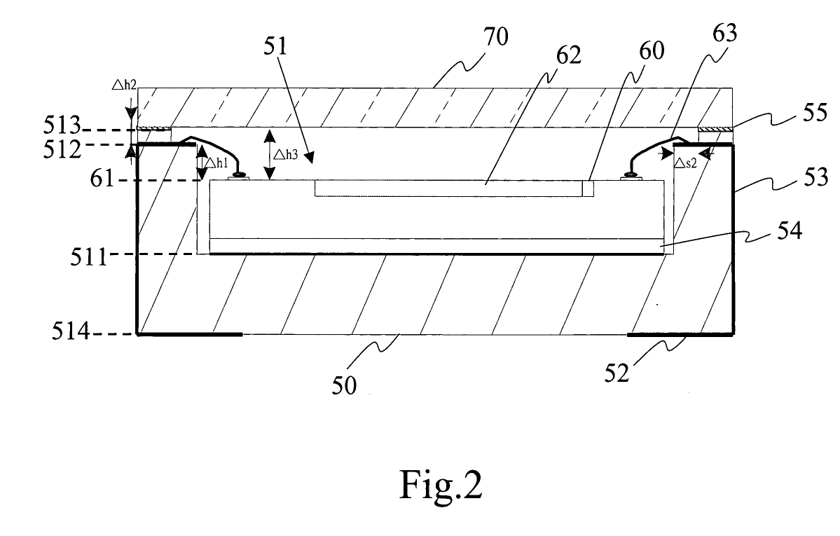

As shown in FIG. 2, an image sensing device package structure of the present invention comprises a base 50, an image sensing device 60, and a light transparent layer 70. The base 50 can be made of ceramic material. A groove 51 is formed on the upper surface of the base 50. A first upper surface 511 is formed at the bottom of the groove 51. The edge of the groove 51 has a difference in height to form a second upper surface 512 and a third upper surface 513 having different horizontal heights. The horizontal height of the second upper surface 512 is larger than that of the first upper surface 511. The horizontal height of the third upper surface 513 is larger than that of the second upper surface 512. Several metallization traces 52 are disposed on the second upper surface 512 and a lower surface 514 of the base 50. The metallization traces 52 on the second upper surface 512 and a lower surface 514 are electrically connected together via a shaped metallization trace 53 at the outside of the base 50.

The image sensing device 60 is adhered to the first upper surface 511 at the bottom of the groove 51. The upper surface 61 of the image sensing device 60 has an image sensing area 62. The horizontal height of the upper surface 61 of the image sensing device 60 is smaller than that of the second upper surface 512 of the base 50. The image sensing device 60 achieves electric connection with the base by means of wire bonding. That is, a first bonding wire ball is placed on the bonding pad of the upper surface 61 of the image sensing device 60, a second bonding wire ball is placed on the second upper surface 512 of the base 50, and a bonding wire 63 is then led from the second bonding wire ball to the first bonding wire ball to achieve electric connection.

The light transparent layer 70 covers on the third upper surface 513 of the base 50 to seal the image sensing device 60. This light transparent layer 70 can be a light transparent glass, or a lens used to filter out a light source with a specific wavelength range, e.g., an IR-cut filtering lens for filtering out far infrared light.

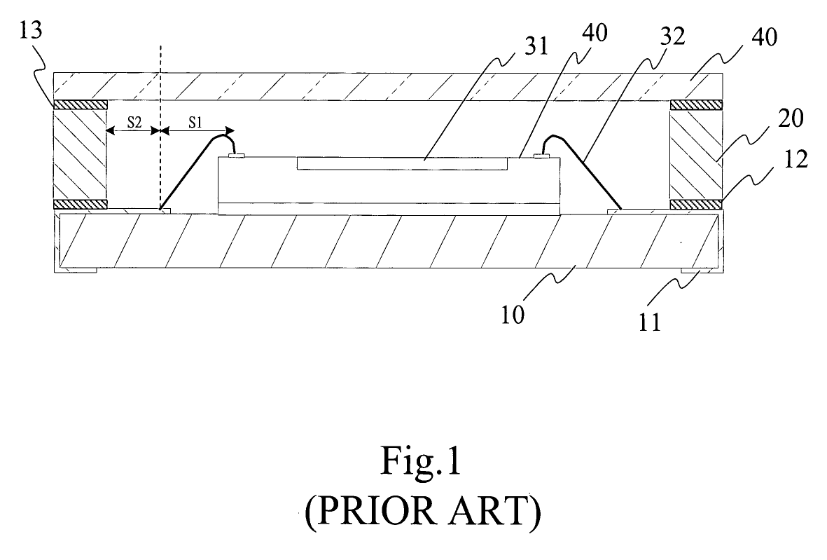

In this embodiment, the groove 51 on the base 50 having a difference in height is used to shorten the wire bonding pitch S1 (FIG. 1) of the conventional bonding wire. Because it is necessary to take the height required for metal recrystallization into account when performing wire bonding to the bonding wire 63, the horizontal height of the second upper surface 52 of the base 50 needs to be larger than that of the upper surface 61 of the image sensing device 60 to conform to the smallest height required for wire bonding. The wire bonding pitch S1 (FIG. 1) required for wire bonding can thus be reduced to decrease the area of the package structure.

For instance, the difference between the horizontal heights Δh1 of the second upper surface 512 of the base 50 and the upper surface 61 of the image sensing device 60 can be larger than 0.1 mm so that the bonding wire 63 can be conveniently led to and connected with the metallization trace on the second upper surface 512 of the base 50 after performing wire ball bonding to the bonding wire 63 on the bonding pad of the image sensing device 60. This difference between the horizontal heights Δh1 is preferred to be larger than 0.2 mm.

Besides, when the bonding wire 63 is led to the second upper surface 512 of the base 50 for wire ball bonding, in order to prevent the capillary tip from touching the edge of the base 50, the height of the third upper surface 513 is lowered to reduce the difference between the horizontal heights Δh2 of the third upper surface 513 and the second upper surface 512 of the base 50. For instance, the difference between the horizontal heights Δh2 of the third upper surface 513 and the second upper surface 512 of the base 50 can be smaller than 0.5 mm or 0.3 mm, and is preferred to smaller than 0.2 mm so as to reduce the required length Δs2 of the second upper surface 512 of the base 50 for shrinking the volume of the package structure.

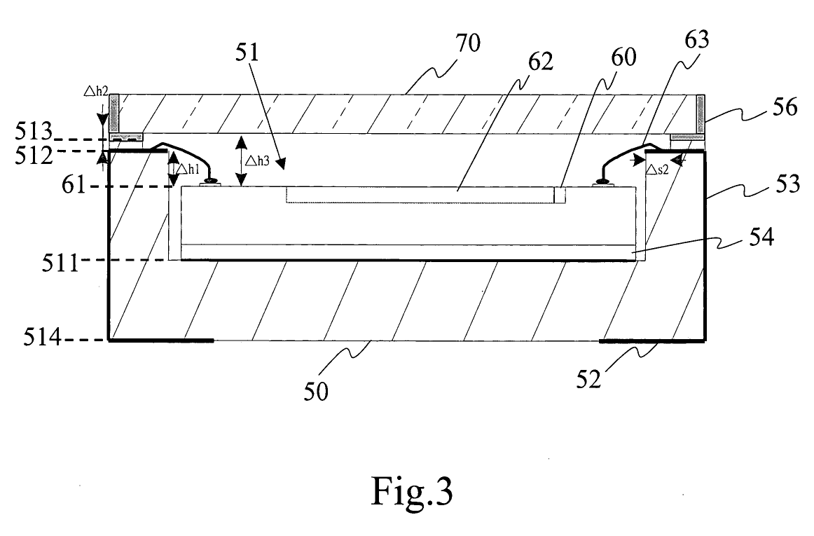

The difference between the horizontal heights Δh3 of the third upper surface 513 of the base 50 and the upper surface 61 of the image sensing device 60 can be smaller than 0.6 mm, and is preferred to be smaller than 0.4 mm. The base 50 can further include an adhesion layer 54 to adhere the image sensing device 60 to the first upper surface 511 of the base 50. The light transparent layer 70 and the third upper surface 513 of the base 50 can be adhered together using a glue layer 55. This glue layer 55 can be a UV glue or a thermosetting glue. Moreover, in practical application, the base 50 can further has a fastening portion 56 to fix the position of the light transparent layer 70, as shown in FIG. 3.

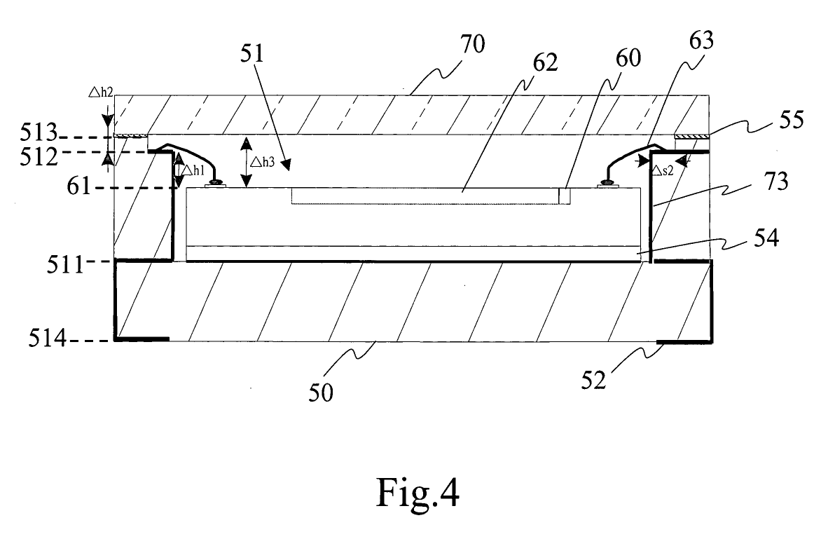

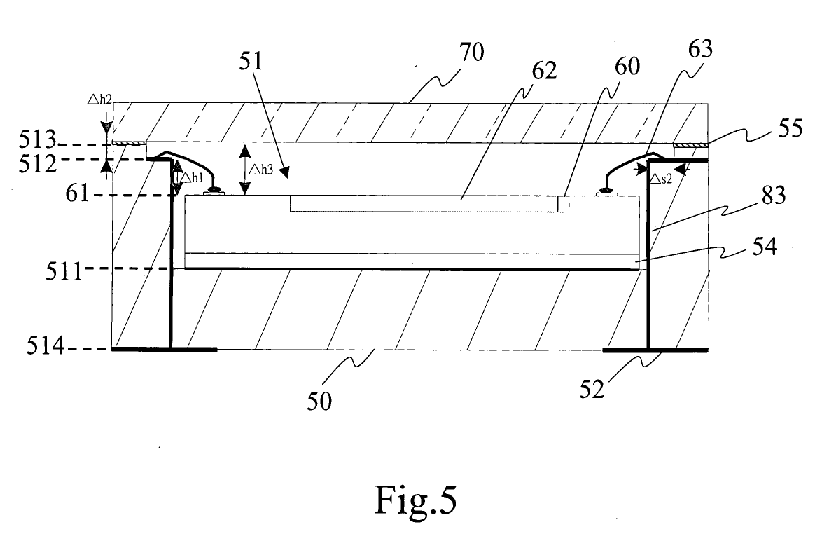

In the above embodiments, the metallization traces 53 of the second upper surface 512 and the lower surface 514 of the base 50 are electrically connected together via a shaped metallization trace at the outside of the base 50. In practice, the shaped metallization trace can be disposed at the inside or outside of the base. As shown in FIG. 4, a metallization trace 73 goes along the inside of the base 50 and extends to the outside of the base 50 after penetrating the base 50 to achieve electric connection of the metallization traces 53; As shown in FIG. 5, a shaped metallization 83 goes along the inside of the base 50 and is directly connected to the metallization traces 53 of the lower surface 514 of the base 50 after penetrating the base 50.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An image sensing device package structure comprising:
an image sensing device;
a base having an upper surface and a lower surface, several metallization traces being provided on said upper and lower surfaces of the base, more than one bonding wire being connected between said image sensing device and said metallization traces on said upper surface of the base, the horizontal height of a top of said metallization traces on said upper surface of the base being higher than the horizontal height of a top of said image sensing device; and
a light transparent layer covering on said upper surface of said base.

2. The image sensing device package structure of claim 1, wherein said base further includes a shaped metallization trace, which electrically connects said metallization traces on said upper and lower surfaces.

3. The image sensing device package structure of claim 2, wherein said shaped metallization trace is disposed at an outside of said base.

4. The image sensing device package structure of claim 2, wherein said shaped metallization trace is disposed at an inside of said base.

5. The image sensing device package structure of claim 4, wherein said shaped metallization trace passes through said base to be electrically connected to said metallization traces on said lower surface.

6. The image sensing device package structure of claim 1, wherein said base is made of ceramic material.

7. The image sensing device package structure of claim 1, wherein said light transparent layer is a light transparent glass.

8. The image sensing device package structure of claim 1, wherein said light transparent layer is a far infrared filter lens.

9. The image sensing device package structure of claim 1 further comprising a glue layer, said glue layer being disposed on said upper surface of said base and used to bond and seal said base and said light transparent layer.

10. The image sensing device package structure of claim 1, wherein a groove is disposed on said upper surface of said base, a first upper surface is formed at a bottom of said groove, an edge of said groove has a difference in height to form a second upper surface and a third upper surface, the horizontal height of said second upper surface is larger than the horizontal height of said first upper surface, the horizontal height of said third upper surface is larger than the horizontal height of said second upper surface, said metallization traces are disposed on said second upper surface and said lower surface, said image sensing device is installed on said first upper surface, the horizontal height of said second upper surface is higher than the horizontal height of an upper surface of said image sensing device, and said light transparent layer covers on said third upper surface.

11. The image sensing device package structure of claim 10, wherein the difference between the horizontal heights of said second upper surface of said base and said upper surface of said image sensing device is larger than 0.1 mm.

12. The image sensing device package structure of claim 11, wherein the difference between the horizontal heights of said second upper surface of said base and said upper surface of said image sensing device is larger than 0.2 mm.

13. The image sensing device package structure of claim 10, wherein the difference between the horizontal heights of said third upper surface of said base and said upper surface of said image sensing device is smaller than 0.6 mm.

14. The image sensing device package structure of claim 13, wherein the difference between the horizontal heights of said third upper surface of said base and said upper surface of said image sensing device is smaller than 0.4 mm.

15. The image sensing device package structure of claim 10, wherein the difference between the horizontal heights of said third upper surface and said second upper surface of said base is smaller than 0.5 mm.

16. The image sensing device package structure of claim 15, wherein the difference between the horizontal heights of said third upper surface and said second upper surface of said base is smaller than 0.3 mm.

17. The image sensing device package structure of claim 15, wherein the difference between the horizontal heights of said third upper surface and said second upper surface of said base is smaller than 0.2 mm.

18. The image sensing device package structure of claim 1, wherein said base further includes an adhesion layer, which is disposed on said upper surface of said base and used to adhere said image sensing device to said upper surface of said base.

19. The image sensing device package structure of claim 1, wherein a fastening portion is further provided at an outside of said base to position said light transparent layer on said upper surface of said base.

20. The image sensing device package structure of claim 1, wherein the difference between the horizontal heights of the top of said metallization traces on said upper surface of said base and the top of said image sensing device is larger than 0.1 mm.

21. The image sensing device package structure of claim 20, wherein the difference between the horizontal heights of the top of said metallization traces on said upper surface of said base and the top of said image sensing device is larger than 0.2 mm.

22. The image sensing device package structure of claim 1, wherein the difference between the horizontal heights of a bottom of said light transparent layer and the top of said image sensing device is smaller than 0.6 mm.

23. The image sensing device package structure of claim 22, wherein the difference between the horizontal heights of a bottom of said light transparent layer and the top of said image sensing device is smaller than 0.4 mm.

24. The image sensing device package structure of claim 1, wherein the difference between the horizontal heights of said light transparent layer and the top of said metallization traces on said upper surface of said base is smaller than 0.5 mm.

25. The image sensing device package structure of claim 24, wherein the difference between the horizontal heights of said light transparent layer and the top of said metallization traces on said upper surface of said base is smaller than 0.3 mm.

26. The image sensing device package structure of claim 24, wherein the difference between the horizontal heights of said light transparent layer and the top of said metallization traces on said upper surface of said base is smaller than 0.2 mm.
